(19) United States
(12) Patent Application Publication
(10) Pub. No.: US 2019/0111900 A1
(43) Pub. Date: Apr. 18, 2019

(54) BRAKING FORCE CONTROL SYSTEM AND METHOD

(71) Applicant: CNH Industrial Canada, Ltd., Saskatoon (CA)

(72) Inventor: Gordon Anthony Engel, Saskatoon (CA)

(73) Assignee: CNH Industrial Canada, Ltd.

(21) Appl. No.: 15/784,872

(22) Filed: Oct. 16, 2017

(51) Int. Cl. B60T 8/17; A01B 76/00; B60T 8/171; B60T 8/172; B60T 8/18

(52) U.S. Cl. CPC B60T 8/1701; A01B 76/00; B60T 8/171; B60T 7/042; B60T 8/18; B60T 8/1837; B60T 8/172

(57) ABSTRACT

A braking force control system for an agricultural system includes a controller including a memory and a processor. The controller is configured to receive a first signal indicative of a first input braking force of a towable implement brake system of a towable implement of the agricultural system, receive a second signal indicative of a first weight of an agricultural product within the towable implement at a first time, determine a first target braking force of the towable implement brake system based at least in part on the first signal and the second signal, determine whether a first current braking force of the towable implement brake system corresponds to the first target braking force of the towable implement brake system, and output to the towable implement brake system, in response to determining that the first current braking force of the towable implement brake system does not correspond to the first target braking force of the towable implement brake system, a third signal indicative of the first target braking force of the towable implement brake system.

### BACKGROUND

The disclosure relates generally to a braking force control system and method for an agricultural system.

Certain implements (e.g., seeders, air carts, harvesters, etc.) are towed behind a tractor or other work vehicle via a mounting bracket secured to a rigid frame of the implement. Seeding implements and harvesting implements may have a change in their payload, or the weight or amount of product carried on the implement, at certain times throughout application or harvesting operations. As such, the implement may vary in weight as product is added or removed. If a constant braking force is applied, stopping distance may increase for heavy loads or braking force may not be enough to stop the implement and the wheels of the implement may lock for light loads.

### BRIEF DESCRIPTION

In one embodiment, a braking force control system for an agricultural system includes a controller including a memory and a processor. The controller is configured to receive a first signal indicative of a first input braking force of a towable implement brake system of a towable implement of the agricultural system, receive a second signal indicative of a first weight of an agricultural product within the towable implement at a first time, determine a first target braking force of the towable implement brake system based at least in part on the first signal and the second signal, determine whether a first current braking force of the towable implement brake system corresponds to the first target braking force of the towable implement brake system, and output to the towable implement brake system, in response to determining that the first current braking force of the towable implement brake system does not correspond to the first target braking force of the towable implement brake system, a third signal indicative of the first target braking force of the towable implement brake system.

In another embodiment, a braking force control system for an agricultural system includes a controller including a memory and a processor. The controller is configured to receive a first signal indicative of an first input braking force of a towable implement brake system of a towable implement of the agricultural system, wherein the first signal is received from a brake pedal or an automatic brake control system of the agricultural system, receive a second signal indicative of a fill level of an agricultural product within the towable implement, determine an estimated weight of the agricultural product based at least in part on the second signal, determine a first target braking force of the towable implement brake system based at least in part on the first signal and the estimated weight, determine whether a first current braking force of the towable implement brake system corresponds to the first target braking force of the towable implement brake system, and output to the towable implement brake system, in response to determining that the first current braking force of the towable implement brake system does not correspond to the first target braking force of the towable implement brake system, a third signal indicative of the first target braking force of the towable implement brake system.

In a further embodiment, a braking force control system of an agricultural system includes a controller including a memory and a processor. The controller is configured to receive a first signal indicative of a first input braking force of a towable implement brake system of a towable implement of the agricultural system, wherein the first signal is received from a brake pedal or an automatic brake control system of the agricultural system, receive a second signal indicative of a product flow rate of the agricultural product to or from the towable implement, determine an estimated weight of the agricultural product within the towable implement based at least in part on the second signal, determine a first target braking force of the towable implement brake system based at least in part on the first signal and the estimated weight, determine whether a first current braking force of the towable implement brake system corresponds to the first target braking force of the towable implement brake system, and output to the towable implement brake system, in response to determining that the first current braking force of the towable implement brake system does not correspond to the first target braking force of the towable implement brake system, a fifth signal indicative of the first target braking force of the towable implement brake system.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an embodiment of an agricultural system that may have a braking force control system, in accordance with an embodiment of the present disclosure;

FIG. 2 is a schematic diagram of an embodiment of a braking force control system that may be used in the agricultural system of FIG. 1, in accordance with an embodiment of the present disclosure;

FIG. 3 is a block diagram of an embodiment of a controller that may be employed within the braking force control system of FIG. 2, in accordance with an embodiment of the present disclosure;

FIG. 4 is a flow diagram of an embodiment of a method for adjusting braking force of components of the agricultural system of FIG. 1, in accordance with an embodiment of the present disclosure;

FIG. 5 is a flow diagram of another embodiment of a method for adjusting braking force of components of the agricultural system of FIG. 1, in accordance with an embodiment of the present disclosure; and

FIG. 6 is a flow diagram of a further embodiment of a method for adjusting braking force of components of the agricultural system of FIG. 1, in accordance with an embodiment of the present disclosure.

### DETAILED DESCRIPTION

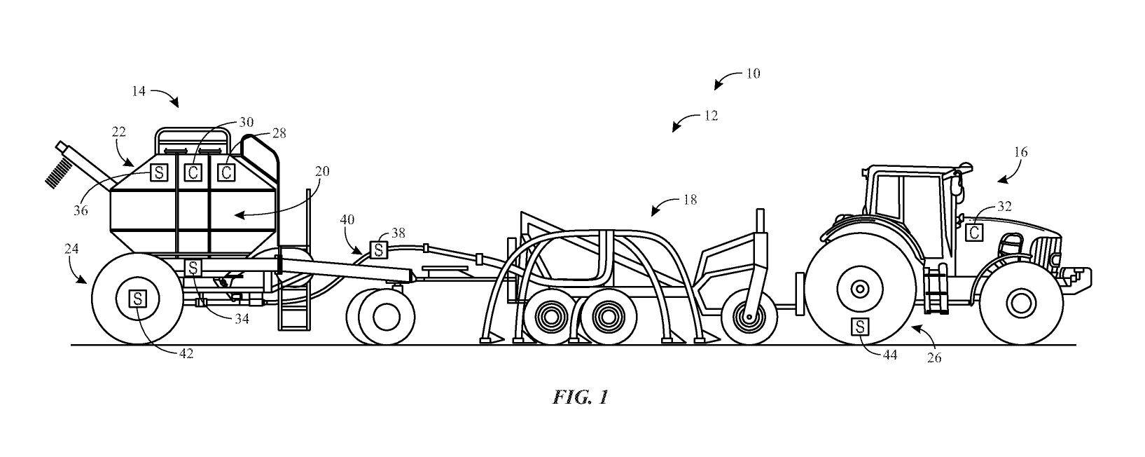

Turning now to the drawings, FIG. 1 is a schematic view of an embodiment of an agricultural system 10 that may have a braking force control system 12. The agricultural system 10 includes a towable implement 14 (e.g., air cart), a work vehicle 16 (e.g., tractor), and a seeding implement 18. The work vehicle 16 is coupled to the seeding implement 18 and used to tow the towable implement 14 and the seeding implement 18. In some embodiments, the work vehicle 16 may be coupled to and used to tow more or fewer towable implements. In addition, the work vehicle 16 may be coupled to the towable implement 14 directly, or via coupling to one or more other implements (e.g., seeding implement 18). The towable implement 14 may be an air cart, a harvester, or any agricultural implement that may experience changes (e.g., increase or decrease) in load or weight during use, such as from product distribution or product harvesting.

In the illustrated embodiment, the towable implement 14 includes a tank 22 that may be used to store the agricultural product 20. The agricultural product 20 may be seed and/or fertilizer, for example. In the illustrated embodiment, the towable implement 14 is an air cart coupled to the seeding implement 18 and is employed to distribute agricultural product 20 (e.g., seeds, fertilizer, etc.) to the seeding implement 18. A blower, such as a fan, and a metering system, which may include a series of meter rollers, are used to control flow of the agricultural product 20 from the tank 22 to the seeding implement 18. The product level and weight of the product in the tank 22 may decrease as the towable implement 14 is towed throughout a field by the work vehicle 16. In some embodiments, the agricultural product 20 may be a harvested product, such as cotton, and the tank 22 of the towable implement 14 may be used to capture the harvested agricultural product 20. As such, the product level and weight of the product in the tank 22 may increase as the towable implement 14 is towed throughout the field.

In some embodiments, the towable implement 14 and the work vehicle 16 may each have independently controlled brake systems. However, in some embodiments, the brake systems may be controlled together. Stopping of the towable implement 14 may be controlled by a towable implement brake system 24 (e.g., including brakes), and stopping of the work vehicle 16 may be controlled by a work vehicle brake system 26 (e.g., including brakes). The brake systems 24, 26 may each produce a braking force used to stop rotation or reduce the rotational speed of the wheels of the towable implement 14 and the work vehicle 16. The braking force applied may be dependent on the weight of the respective component of the agricultural system 10 (e.g., the towable implement 14 and the work vehicle 16). Further, the braking force applied by the towable implement brake system 24 and the braking force applied by the work vehicle brake system 26 may be related to each other.

The braking force control system 12 may include one or more controllers and sensors disposed throughout the agricultural system 10. The one or more sensors may communicate wirelessly or via a wired circuit with the controllers of the braking force control system 12. The braking force control system 12 may control the braking force applied by the towable implement brake system 24 and the braking force applied by the work vehicle brake system 26. Further, the braking forces may be controlled together or individually. The braking force control system 12 may include a braking force controller 28. In the illustrated embodiment, the braking force controller 28 is disposed on the towable implement 14. However, in other embodiments, the braking force controller may be disposed on the work vehicle, or any other location on the agricultural system suitable for controlling the braking force applied to the towable implement and/or the work vehicle. In some embodiments, the braking force controller 28 may be disposed remotely from the agricultural system 10. The braking force controller 28 may include a memory and a processor and may be communicatively coupled to one or more sensors of the braking force control system 12.

The braking force controller 28 may control the braking force applied to the wheels of towable implement 14 and/or the wheels of work vehicle 16 based on a real-time or near real-time weight of the agricultural product 20 within the tank 22, and as such, a weight of the towable implement 14. The braking force controller 28 may use the weight to determine a braking force to be applied to the wheels of the towable implement 14 and/or the wheels of the work vehicle 16. The braking force control system 12 may include a towable implement controller 30 and a work vehicle controller 32. The braking force controller 28 may be communicatively coupled to the towable implement controller 30 and the work vehicle controller 32. In some embodiments, the braking force controller 28 may receive signals from the various sensors of the braking force control system 12 via the towable implement controller 30 and/or the work vehicle controller 32. However, in some embodiments, the braking force controller 28 may receive signals directly from the various sensors discussed below. Similarly, in some embodiments, the braking force controller 28 may output signals to control the braking force applied to the wheels of the towable implement 14 and/or the wheels of the work vehicle 16 to the controllers 30, 32 of the towable implement 14 and the work vehicle 16, respectively. However, in some embodiments, the braking force controller 28 may output signals directly to the towable implement brake system 24 and/or the work vehicle brake system 26.

In some embodiments, the weight used by the braking force controller 28 to determine the braking force may be an actual weight of the agricultural product 20 within the tank 22 of the towable implement 14. In some embodiments, the braking force control system 12 may include a scale sensor 34, which may be disposed on the towable implement 14 below the tank 22, or in any position suitable for measuring the weight of the agricultural product 20 within the tank 22. The scale sensor 34 may output a signal indicative of the measured weight of the agricultural product 20 in the tank 22 to the towable implement controller 30 and/or to the braking force controller 28. In some embodiments, the towable implement controller 30 may determine the weight of the agricultural product 20 within the tank 22 based on the signal from the scale sensor 34 and output the determined weight to the braking force controller 28. In some embodiments, the scale sensor 34 may output the signal indicative of the measured weight of the agricultural product 20 within the tank 22 directly to the braking force controller 28. The braking force controller 28 may determine a target braking force based at least in part on the signal received from the scale sensor 34 and/or the towable implement controller 30. The braking force controller 28 may further determine the target braking force based on a pedal position of a brake pedal that may be depressed to stop or slow the towable implement 14, or on an input from an automatic brake system, as well.

In some embodiments, the weight used by the braking force controller 28 to determine the braking force may be an estimated weight. In some embodiments, the weight of the agricultural product 20 may be estimated based on feedback from a level sensor 36. The braking force control system 12 may include the level sensor 36, which may be disposed within or on the tank 22 and may measure a fill level of the agricultural product 20 within the tank 22. The level sensor 36 may output a signal indicative of the measured fill level of the agricultural product 20 within the tank 22 to the towable implement controller 30 and/or to the braking force controller 28. In some embodiments, the towable implement controller 30 may determine the fill level of the agricultural product 20 within the tank 22 based on the signal from the level sensor 36 and output the determined fill level to the braking force controller 28. In some embodiments, the level sensor 36 may output the signal indicative of the measured fill level of the agricultural product 20 within the tank 22 directly to the braking force controller 28, and the braking force controller 28 may determine an estimated weight of the agricultural product 20 within the tank 22 based at least in part on the signal received from the level sensor 36. The braking force controller 28 may determine the target braking force based at least in part on the signal received from the scale sensor 34 and/or the determined estimated weight of the agricultural product 20 within the tank 22. The braking force controller 28 may further determine the target braking force based on a pedal position of a brake pedal that may be depressed to stop or slow the towable implement 14, or on an input from an automatic brake system, as well.

In some embodiments, the estimated weight of the agricultural product 20 within the tank 22 may be determined based on a product flow rate of the agricultural product 20 from the tank 22. In some embodiments, the braking force control system 12 may include a product flow sensor 38, which may be disposed along one or more conduits 40 of the towable implement 14 that may extend from the tank 22. However, in some embodiments, the estimated weight may be determined based on input from a meter roller speed sensor or an input from a meter roller controller that may instruct a motor to drive the meter roller at a target speed. In the illustrated embodiment, the conduits 40 carry the agricultural product 20 from the tank 22 on the towable implement 14 to the seeding implement 16 (e.g., to row units on the seeding implement), which may be used to plant the agricultural product 20 throughout the field. In some embodiments, the conduits 40 may convey the agricultural product 20 from the ground or another towable implement to the tank 22 of the towable implement 14, for example, in the case of harvested agricultural product. In such embodiments, the estimated weight of the agricultural product within the tank may be determined based on a product flow rate of the harvested agricultural product into the tank.

The product flow sensor 38 may measure a flow rate of the agricultural product 20 from the tank 22 of the towable implement 14. The product flow sensor 38 may output a signal indicative of the measured product flow rate of the agricultural product 20 to the towable implement controller 30 and/or to the braking force controller 28. In some embodiments, the towable implement controller 30 may determine the product flow rate of the agricultural produce 20 based on the signal from the product flow sensor 38 and output the determined product flow rate to the braking force controller 32. In some embodiments, the product flow sensor 38 may output the signal indicative of the measured product flow rate of the agricultural product 20 directly to the braking force controller 28. The braking force controller 28 may also receive a start time when the seeding or harvesting operations began and a current time at which the product flow rate is measured by the product flow sensor 38. The braking force controller 28 may determine an estimated weight of the agricultural product 20 in the tank 22 based at least in part on the signal received from the product flow sensor 38 and the amount of time that the current seeding or fertilizing operation of the agricultural system 10 has been engaged. For example, since the product flow rate may change, the braking force controller 28 may multiply the product flow rate by the time at that rate, or the braking force controller 28 may determine the rate at a particular interval of time and multiply the product flow rate by the interval time. In embodiments where the agricultural system 10 is used for harvesting operations, the conduits 40 may convey the agricultural product 20 from the ground to the tank 22, and the product flow sensor 38 may measure the flow rate of the agricultural product 20 as it is conveyed to the tank 22. Thus, the braking force controller 28 may determine the estimated weight of the harvested agricultural product 20 in within the tank 22 based on the product flow rate and the amount of time that the current harvesting operation has been engaged. Further, the braking force controller 28 may determine the target braking force based at least in part on the determined estimated weight of the agricultural product 20 (e.g., seed, fertilizer, or harvested product) in the tank 22. The braking force controller 28 may further determine the target braking force based on a pedal position of a brake pedal that may be depressed to stop or slow the towable implement 14, or on an input from an automatic brake system, as well.

The braking force controller 28 may use the determined target braking force to control the towable implement braking system 24. After determining the target braking force using any or all of the signals from the sensors described above, including the weight sensor 34, the level sensor 36, and the product flow sensor 36, the braking force controller 28 may output a signal instructing the towable implement brake system 24 to apply the determined target braking force. In some embodiments, the braking force controller 28 may output the instruction signal to the towable implement controller 30, and the towable implement controller 30 may output the instruction signal to the towable implement brake system 24. In some embodiments, the braking force controller 28 may output the instruction signal to the towable implement brake system 24 directly. The instruction signal output by the braking force controller 28 may instruct the towable implement brake system 24 (e.g., brakes of the brake system) to increase or decrease the braking force to stop or to reduce the speed of the towable implement 14.

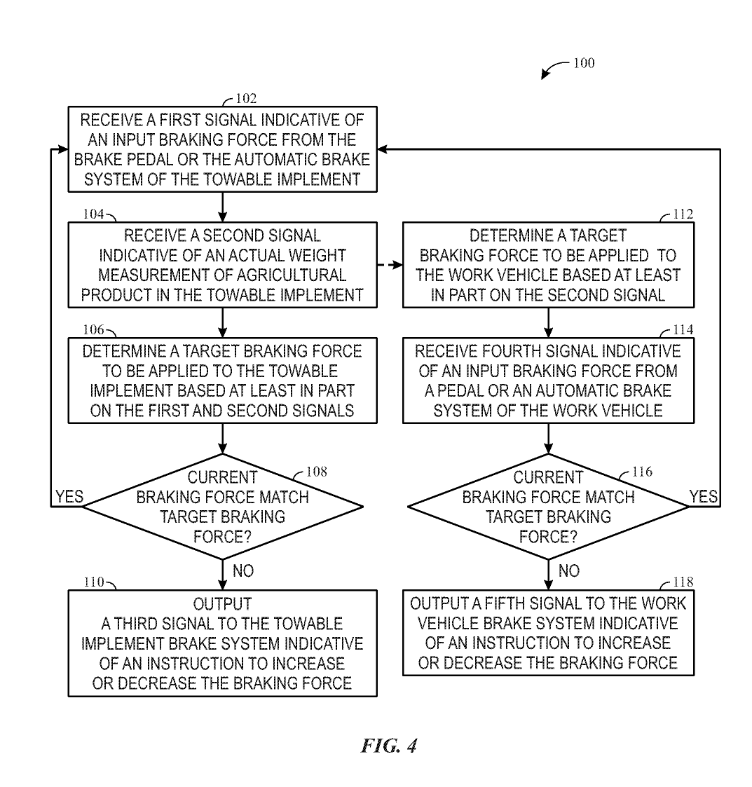

The braking force control system 12 may include one or more towable implement brake force sensors 42 that may be disposed on one or more brakes of the towable implement 14 or at any position on the towable implement brake system 24 suitable for measuring a current applied braking force. The towable implement brake force sensor 42 may measure the current braking force applied by the towable implement brake system 24, and may output a signal indicative of the measured current braking force to the towable implement controller 30 and/or to the braking force controller 28. In some embodiments, the towable implement brake force sensor 42 may output a signal indicative of the current braking force to the towable implement controller 30, and the towable implement controller 30 may output the signal to the braking force controller 28. In some embodiments, the towable implement brake force sensor 42 may output the signal indicative of the measured current braking force to the braking force controller 28 directly. The braking force controller 28 may use the measured current braking force received from the towable implement brake force sensor 42 to determine whether to adjust the braking force based on the determined target braking force, as discussed in greater detail with reference to FIGS. 4-6. To adjust the braking force, the braking force controller 28 may output a control signal to the towable implement brake system 24 and/or to the towable implement controller 30 indicative of an increase or decrease in braking force.

Additionally or alternatively, in some embodiments, the braking force controller 28 may control the braking force applied to the work vehicle brake system 26 of the work vehicle 16. As such, the braking force controller 28 may control the braking force applied by the towable implement brake system 24, the braking force applied by the work vehicle brake system 26, or both braking forces. In some embodiments, the braking force control system 12 may include one or more work vehicle brake force sensors 44 that may be disposed on one or more brakes of the work vehicle 16 or at any position on the work vehicle brake system 26 suitable for measuring the current applied braking force. Similar to the towable implement brake force sensor 42, the work vehicle brake force sensor 44 may measure the current braking force applied by the work vehicle brake system 26, and may output a signal indicative of the measured current braking force to the work vehicle controller 32 and/or to the braking force controller 28. In some embodiments, the work vehicle brake force sensor 44 may output a signal indicative of the current braking force to the work vehicle controller 32, and the work vehicle controller 33 may output the signal to the braking force controller 28. In some embodiments, the work vehicle brake force sensor 44 may output the signal indicative of the measured current set braking force to the braking force controller 28 directly. The braking force controller 28 may use the measured current braking force received from the work vehicle brake force sensor 44 to determine whether to adjust the braking force applied by the work vehicle brake system 26, as discussed in greater detail with reference to FIGS. 4-6. To adjust the braking force, the braking force controller 28 may output a control signal to the work vehicle brake system 26 and/or to the work vehicle controller 32 indicative of an increase or decrease in braking force.

Additionally, the signals indicative of the current towable implement braking from the sensor 42 and/or the work vehicle braking force from the sensor 44 may be used by the braking force controller 28 as feedback for controlling the braking. Control of the braking force applied to the wheels of the towable implement 14 and/or to the wheels of the work vehicle 16 may enable calibration of the brake systems 24, 26 of the towable implement 14 and/or the work vehicle 16, respectively, and braking of the overall agricultural system 10. Certain braking systems use a fixed calibration for mapping input braking force (e.g., from a pedal or an automatic control system) to applied braking force. In such brake systems, the calibration is based on a fixed weight (e.g., 0% full, 50% full, 100% full). However, if the actual weight of the agricultural product within the tank of the towable implement is higher than the calibration weight, then stopping distance of the agricultural system increases. If the actual weight of the agricultural product within the tank of the towable implement is lower than the calibration weight, then the wheels of the towable implement and/or the wheels of the wheels of the work vehicle will lock. The braking force control system 12 may enable calibration of the braking force(s) based on real-time or near real-time weight of the agricultural product 20. Thus, the braking force control system 12 may enable a decrease in locking of the wheels of the towable implement 14 and/or the wheels of the work vehicle 16 when the weight of the agricultural product 20 within the tank 22 is low, and a decrease in increased stopping distance when the weight of the agricultural product 20 within the tank 22 is high.

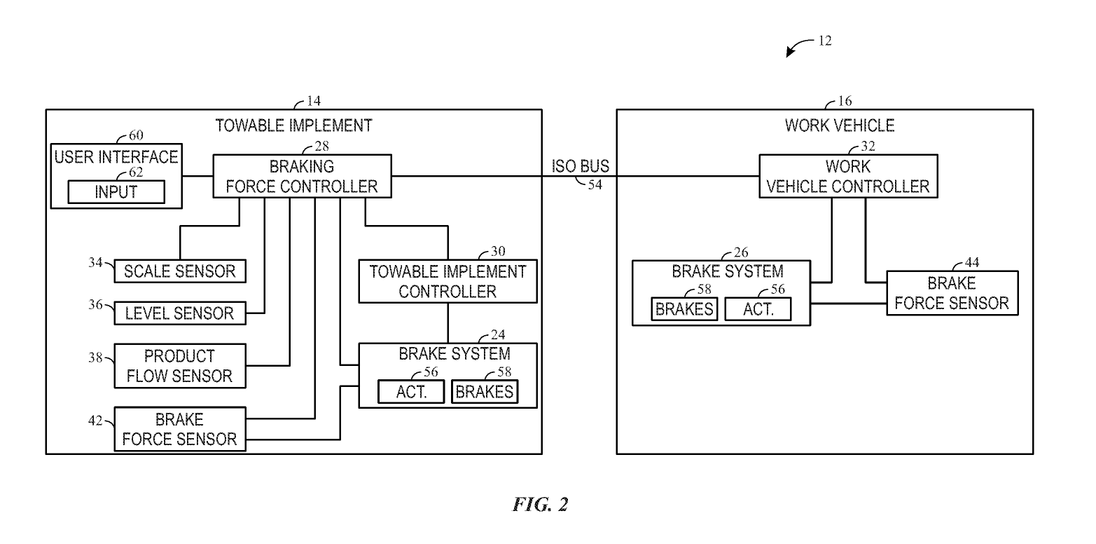

FIG. 2 is a schematic diagram of an embodiment of a braking force control system 12 for controlling the braking force used to stop or to reduce the speed of the towable implement 14 and/or the work vehicle 16 of the agricultural system 10. The braking force control system 12 includes the various controllers, including the braking force controller 28, the towable implement controller 30, and the work vehicle controller 32, and sensors, including the scale sensor 23, the level sensor 36, the product flow sensor 38, and the brake force sensors 42, 44, discussed above. The braking force control system 12 may also include various actuators of the towable implement brake system 24 and/or the work vehicle brake system 26. The braking force control system 12 includes the braking force controller 28 that is communicatively coupled to and configured to communicate with the towable implement controller 30 and the work vehicle controller 32 via an ISOBUS network 54. As previously discussed, the braking force controller 28 may be configured to receive signals from various sensors throughout the agricultural system 10. The braking force controller 28 may also be configured to control the braking force applied by the towable implement brake system 24 (e.g., including brakes) to stop and/or to reduce the speed of the towable implement 14. Additionally or alternatively, the braking force controller 28 may be configured to control the braking force applied by the work vehicle brake system 26 (e.g., including brakes) to stop and/or to reduce the speed of the work vehicle 16.

The towable implement 14 may support a variety of sensors of the braking force control system 12, as discussed above, such as the scale sensor 34, the level sensor 36, the product flow sensor 38, and the towable implement brake force sensor 42. These sensors are communicatively coupled to the braking force controller 28 and may be configured to output respective to the braking force controller 28 indicative of measurements. In some embodiments, the sensors may output the respective measurement signals directly to the braking force controller 28. In some embodiments, the sensors may be communicatively coupled to the towable implement controller 30 and may be configured to output the respective signals to the towable implement controller 30. In such embodiments, the towable implement controller 30 may be configured to receive the signals from the respective sensors and to output the corresponding signals to the braking force controller 28.

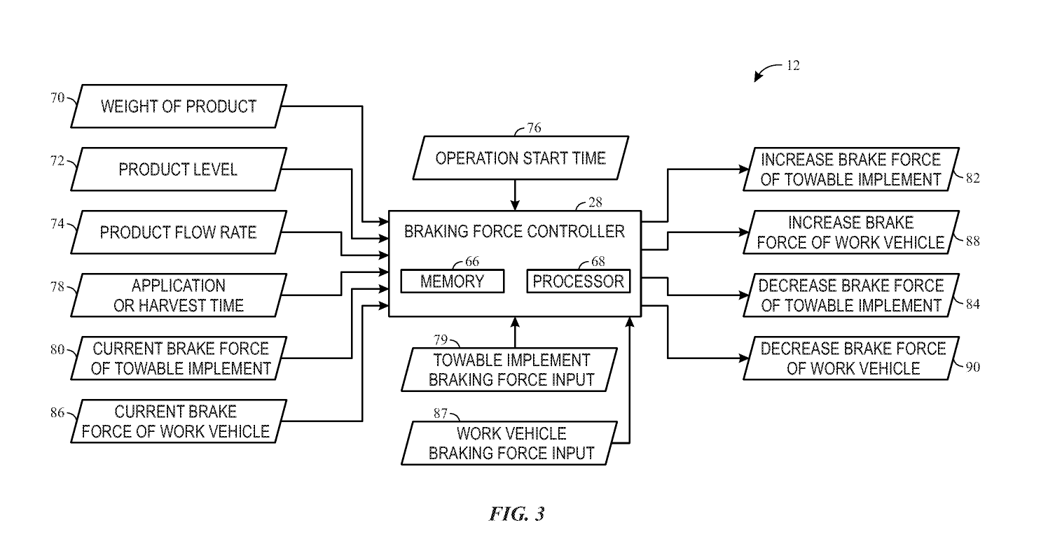

In the illustrated embodiment, the braking force controller 28 is mounted on the towable implement 14, however, in some embodiments, the braking force controller 28 may be disposed remote from the towable implement 14 (e.g., on the work vehicle) or the agricultural system 10. The braking force controller 28 may be communicatively coupled to the towable implement controller 30 via the ISOBUS network 54 or any other suitable communication system. The braking force controller 28 may be configured to control the braking force applied to the wheels of the towable implement 14. The braking force controller 28 may be configured to output one or more signals indicative of instructions to control the braking force based at least in part on the one or more signals received from the various sensors, including the scale sensor 34, the level sensor 36, the product flow sensor 38, and the brake force sensor 42, as discussed in greater detail with reference to FIG. 3. In some embodiments, the braking force controller 28 may be configured to output the instruction signals directly to the towable implement brake system 24 or individual brakes of the towable implement brake system 24. In some embodiments, the braking force controller 28 may be configured to output the instruction signals to the towable implement controller 30, and the towable implement controller 30 may output the instruction signals to the towable implement brake system 24 or the individual brakes.

The work vehicle may support one or more sensors of the braking force control system 12, as discussed above, including the one or more work vehicle brake force sensors 44. The work vehicle brake force sensor(s) 44 are communicatively coupled to the braking force controller 28 and may be configured to output signals indicative of measurements of the braking force applied to wheels of the work vehicle 16. In some embodiments, the work vehicle brake force sensor 44 may output the measurement signal directly to the braking force controller 28. In the illustrated embodiment, the work vehicle brake force sensor 44 is communicatively coupled to the work vehicle controller 32 and configured to output the signals to the work vehicle controller 32 indicative of measurements of the braking force. In such embodiments, the work vehicle controller 32 may be configured to receive the signals from the work vehicle brake force sensor 44 and to output the signals to the braking force controller 28.

In the illustrated embodiment, the braking force controller 28 is communicatively coupled to the work vehicle controller 32 via the ISOBUS network 54 or any other suitable communication system. The braking force controller 28 may be configured to control the braking force applied to the wheels of the work vehicle 16. The braking force controller 28 may be configured to output one or more signals indicative of instructions to control the braking force of the work vehicle based at least in part on the one or more signals received from the work vehicle brake force sensor 44 and/or the signals received from the various sensors of the towable implement 14, as discussed in greater detail with reference to FIG. 3. In some embodiments, the braking force controller 28 may be configured to output the instruction signals directly to the work vehicle brake system 26 or individual brakes of the work vehicle brake system 26. In the illustrated embodiment, the braking force controller 28 is configured to output the instruction signals to the work vehicle controller 32, and the work vehicle controller 32 is configured to output the instruction signals to the work vehicle brake system 26 or to the individual brakes.

The braking force controller 28 may be configured to receive signals indicative of operational parameters from the various sensors on the towable implement 14 and the work vehicle 16. The braking force controller 28 may receive these signals directly from the sensors and/or from the towable implement controller 30 and/or the work vehicle controller 32. In embodiments in which the sensors communicate directly with the braking force controller 28, the towable implement controller 30 and/or the work vehicle controller 32 may be omitted. Further, in some embodiments, more or fewer sensors may be included in the braking force control system 12, including the scale sensor 34, the level sensor 36, the product flow sensor 38, and brake force sensors 42, 44. The braking force controller 28 may utilize the signal(s) received from the sensors as inputs to determine a target braking force to be applied to the wheels of the towable implement 14 and/or the work vehicle 16, and/or as feedback to the braking force controller 28. The braking force controller 28 may be further configured to determine the target braking force based on inputs, such as an operational start time, a brake pedal position, and/or an input from an automatic brake system. The braking force controller 28 may be further configured to output instructions to actuators 56 of the brake systems 24, 26 including the actuators 56 as a whole, or individual actuators 56 for individual brakes 58, instructing the actuators to control the braking force applied to stop and/or reduce the speed of the towable implement 14 and/or the work vehicle 16. The output instruction signals may be directed to the various actuators 56 of the brake systems 24, 26 of the towable implement 14 and/or the work vehicle 16, respectively, via the ISOBUS network 54. In some embodiments, the braking force controller 32 may output the instruction signals to a valve assembly communicatively coupled to the braking force controller 32 and configured to control fluid pressure to the actuator 56. In the illustrated embodiment, the braking force control system 12 includes a user interface 60 including an input 62 for the braking force (e.g., a brake pedal or an automatic brake system). The braking input from the user interface 60 may be used to determine the target braking force, as previously discussed.

FIG. 3 is a block diagram of an embodiment of the braking force controller 28 that may be employed with the braking force control system 12 of FIG. 2. The braking force controller 28 includes a memory 66 and a processor 68. In some embodiments, the memory 66 may include one or more tangible, non-transitory, computer-readable media that store instructions executable by the processor 68 and/or data to be processed by the processor 68. For example, the memory 66 may include access memory (RAM), read only memory (ROM), rewritable non-volatile memory such as flash memory, hard drives, optical discs, and/or the like. Additionally, the processor 68 may include one or more general purpose microprocessors, one or more application specific processors (ASICs), one or more field programmable logic arrays (FPGAs), or any combination thereof. In operation, the braking force controller 28 may receive various input signals from sensors throughout the towable implement 14 and/or the work vehicle 16 at the processor 68. In some embodiments, these input signals and/or control signals (e.g., instruction signals) output by the braking force controller 28 may be stored in the memory 86. The input signals may be utilized individually or in various combinations to determine target braking force(s) of the brake system(s) of the towable implement 14 and/or the work vehicle 16 of the agricultural system 10. The braking force controller 28 may then output various instruction signals to actuators 56 of the brake system(s) 24, 26 of the towable implement 14 and/or the work vehicle 16 to achieve the determined target braking force(s). The sensors may further provide feedback to the braking force controller 28 upon output of the instruction signals by the braking force controller 28.

e from the towable implement 14 (may receive one or more signals indicative of weight or amount of the agricultural product that may be within the tank of the towable implement. The towable implement may be used to distribute or harvest the agricultural product and, as such, the weight or amount of the agricultural product within the towable implement may vary throughout operation. The braking force controller 28 may receive a signal 70 indicative of a weight of the agricultural product within the tank of the towable implement. The signal 70 may be received by the braking force controller 28 from the scale sensor directly, or from the towable implement controller. In some embodiments, based at least in part on the signal 70 indicative of the weight of the agricultural product within the towable implement, the braking force controller 28 may determine a target braking force that may be used to stop or reduce the speed of the towable implement.

Additionally or alternatively, the braking force controller 28 may receive a signal 72 indicative of a level of the agricultural product within the tank of the towable implement. The braking force controller 28 may receive the signal 72 indicative of the level of the agricultural product from the level sensor directly, or from the towable implement controller. In some embodiments, based at least in part of the signal 72 indicative of the agricultural product level, the braking force controller 28 may determine a target braking force that may be used to stop or reduce the speed of the towable implement. The braking force controller 28 may utilize the product level signal 72 to determine an estimated weight of the agricultural product within the towable implement, and the estimated weight may be used by the braking force controller 28 to determine the target braking force.

Additionally or alternatively, the braking force controller 28 may receive a signal 74 indicative of a product flow rate of the agricultural product to or from the towable implement during harvesting or distribution operations, respectively. The braking force controller 28 may receive the signal 74 indicative of the product flow rate from the product flow sensor directly, or from the towable implement controller. Further, in some embodiments, the braking force controller 28 may receive a signal 76 indicative of an operational start time of the current agricultural operation. The signal 76 may be input be an operator or received from a sensor or timer disposed at any location about the agricultural system suitable for monitoring an operational start time. Further, in some embodiments, the braking force controller 28 may receive a signal 78 indicative of an application (e.g., distribution) time or harvesting time of the current operation. The application or harvesting time may be the time at which the current operation has been engaged since the start time of the current operation. The braking force controller 28 may determine an estimated weight of the agricultural product 20 in the tank 22 based at least in part on the signal received from the product flow sensor 38 and the amount of time that the current seeding or fertilizing operation of the agricultural system 10 has been engaged. For example, since the product flow rate may change, the braking force controller 28 may multiply the product flow rate by the time at that rate, or the braking force controller 28 may determine the rate at a particular interval of time and multiply the product flow rate by the interval time. The braking force controller 28 may utilize the estimated weight to determine the target braking force.

Additionally, the braking force controller 32 may receive an input 79 from the brake pedal or automatic brake system indicative of a braking force applied by an operator or the automatic brake system. The braking force controller 32 may further determine the target braking force based at least in part on the braking force input 79, as well as the actual or estimated weight of the agricultural product within the towable implement, as discussed above. If the braking force controller 28 determines that the braking force input 79 does not match the target braking force, the braking force controller 28 may output control signals to the towable implement brake system to apply the target braking force. For example, if the braking force input 79 is lower than the target braking force for the weight of the agricultural product within the tank of the towable implement, the braking force controller 28 may output a signal 82 indicative of an instruction to the towable implement brake system to increase the braking force applied to the wheels of the towable implement. If the braking force input 79 is higher than the target braking force for the weight of the agricultural product within the tank of the towable implement, the braking force controller 28 may output a signal 84 indicative of an instruction to the towable implement brake system to decrease the braking force applied to the wheels of the towable implement. In some embodiments, the control signals 82 and 84 output by the braking force controller 28 may be received by the actuators of the towable implement brake system directly. In other embodiments, the signals 82 and 84 may be received by the towable implement controller and subsequently output to the actuators of the towable implement brake system.

In some embodiments, the braking force controller 28 may receive a signal 80 indicative of a current brake force applied by the towable implement brake system of the towable implement. The braking force controller 28 may receive the signal 80 from the one or more towable implement braking force sensors directly, or from the towable implement controller. In some embodiments, the current braking force signal 80 received from the towable implement braking force sensor may be utilized as feedback by the braking force controller 28 to determine whether the current braking force of the towable implement brake system 24 matches (e.g., corresponds to) the target braking force for the towable implement brake system. Based on this comparison, the braking force controller 28 may output a signal indicative of instructions to further adjust the braking force applied by the towable implement brake system.

Additionally or alternatively, the braking force controller 28 may be used to control the braking force applied to the wheels of the work vehicle of the agricultural system. The weight or estimated weight of the agricultural product within the towable implement being towed by the work vehicle (e.g., as determined by the braking force controller 28 based at least in part on the signals 70, 72, 74, 76, 78 and/or 79) may be used by the braking force controller 28 to determine the target braking force for the work vehicle brake system. In some embodiments, the target breaking force determined for the towable implement may be used in determining the target braking force for the work vehicle. In some embodiments, the braking force controller 28 may determine the target breaking force for the work vehicle based at least in part on the actual or estimated weight of the agricultural product within the towable implement and on an input 87 received from a brake pedal or an automatic brake system indicative of a braking force applied by an operator or the automatic brake system. If the braking force controller 28 determines that the braking force input 87 does not match the target braking force, the braking force controller 28 may output signals to the work vehicle brake system to apply the target braking force. For example, if the braking force input 87 is lower than the target braking force for the weight of the agricultural product within the tank of the towable implement, the braking force controller 28 may output a signal 88 indicative of an instruction to the work vehicle brake system to increase the braking force that applied to the wheels of the work vehicle. If the braking force input 87 is higher than the target braking force for the weight of the agricultural product within the tank of the towable implement, the braking force controller 28 may output a signal 90 indicative of an instruction to the work vehicle brake system to decrease the braking force that applied to the wheels of the work vehicle. In some embodiments, the control signals 88 and 90 output by the braking force controller 28 may be received by the actuators of the work vehicle brake system directly. In other embodiments, the signals 88 and 90 may be received by the work vehicle controller and subsequently output to the actuators of the work vehicle brake system.

In some embodiments, the braking force controller 28 may receive a signal 86 indicative of a current brake force applied by the work vehicle brake system. The braking force controller 28 may receive the signal 86 from the one or more work vehicle braking force sensors directly, or from the work vehicle controller. In some embodiments, the current braking force signal 86 received from the work vehicle braking force sensor may be utilized as feedback by the braking force controller 28 to determine whether the current braking force of the work vehicle brake system matches (e.g., corresponds to) the target braking force for the work vehicle brake system. Based on this comparison, the braking force controller 28 may output a signal indicative of instructions to further adjust the braking force applied by the work vehicle brake system.

FIG. 4 is a flow diagram of an embodiment of a method 100 for calibrating the braking force applied to the wheels of the towable implement and/or the wheels of the work vehicle of the agricultural system of FIG. 1. The method 100 may include determination of a weight of the agricultural product within the towable implement at a given time based at least in part on signal(s) received from the scale sensor, and adjustment of one or more braking forces based at least in part on the weight. First, as represented by block 102, a first signal indicative of a braking force input from the brake pedal or from the automatic brake system of the towable implement may be received by the braking force controller. Next, as represented by block 104, a second signal indicative of a current weight measurement of the agricultural product within the towable implement is received by the braking force controller from the scale sensor or the towable implement controller. Next, as represented by block 106, based at least in part on the first and second signals, the braking force controller may determine a target braking force to be applied by the towable implement brake system to stop or reduce the speed of the towable implement. The target braking force may be calibrated for the current weight of the agricultural product within the towable implement, and as such, the current weight of the towable implement.

Next, as represented by block 108, the braking force controller may determine whether a current braking force of the towable implement brake system matches the target braking force of the towable implement brake system. The current braking force may be received by the controller from the one or more towable implement brake force sensors. If the current braking force matches the target braking force, the method 100 may begin again with block 102 and continue throughout the operation as a braking force is applied to stop or reduce the speed of the towable implement and the weight of the agricultural product on the towable implement changes. If the braking force controller determines that the current braking force does not match the target braking force for the towable implement brake system, the braking force controller may output a third signal to the towable implement brake system, or the individual actuators of the individual brakes of the towable implement, indicative of the target braking force and/or of an instruction to either increase or decrease the current braking force to match the target braking force, as represented by block 110. Calibration of the braking force applied by the towable implement brake system based on real-time or near real-time weight of the agricultural product within the towable implement during application or harvesting operations may enable a decrease in locking of the wheels of the towable implement 14 and/or the wheels of the work vehicle 16 when the weight of the agricultural product 20 within the tank 22 is low, and a decrease in increased stopping distance when the weight of the agricultural product 20 within the tank 22 is high.

In some embodiments, the braking force controller may next receive signals from the one or more towable implement braking force sensor that may be utilized by the braking force controller as feedback to determine whether the current braking force of the towable implement brake system matches the target braking force. Based on this comparison, in some embodiments, the braking force controller may output a signal indicative of instructions to further adjust the current braking force of the towable implement brake system if the current braking force does not match the target braking force.

Additionally or alternatively, in some embodiments, the braking force controller may control the braking force applied by the work vehicle brake system to stop or reduce the speed of the work vehicle. After the target braking force of the towable implement is determined by the braking force controller (block 104), the braking force controller may determine a target braking force for the work vehicle brake system based at least in part on the second signal indicative of the current weight of the agricultural product within the towable implement, as represented by block 112. The braking force controller may further determine the target braking force of the work vehicle brake system based at least in part on a received fourth signal indicative of an input braking force by the brake pedal or the automatic brake system of the work vehicle (block 114). Next, as represented by block 116, the braking force controller may determine whether a current braking force of the work vehicle brake system matches the target braking force of the work vehicle brake system. The current braking force may be received by the controller from the one or more work vehicle brake force sensors. If the current braking force matches the target braking force, the method 100 may begin again with block 102 and continue throughout the operation as a braking force is applied to stop or reduce the speed of the work vehicle and the weight of the agricultural product on the towable implement changes. If the braking force controller determines that the current braking force does not match the target braking force for the work vehicle brake system, the braking force controller may output a fifth signal to the work vehicle brake system, or the individual actuators of the individual brakes of the work vehicle, indicative of the target braking force and/or of an instruction to either increase or decrease the current braking force to match the target braking force, as represented by block 118. Calibration of the braking force applied by the work vehicle brake system based on real-time or near real-time weight of the agricultural product within the towable implement during application or harvesting operations may enable a decrease in locking of the wheels of the towable implement and/or the wheels of the work vehicle when the weight of the agricultural product within the tank is low, and a decrease in increased stopping distance when the weight of the agricultural product within the tank is high.

In some embodiments, the braking force controller may next receive signals from the one or more work vehicle braking force sensor that may be utilized by the braking force controller as feedback to determine whether the current braking force of the work vehicle brake system matches the target braking force. Based on this comparison, in some embodiments, the braking force controller may output a signal indicative of instructions to further adjust the current braking force of the work vehicle brake system if the current braking force does not match the target braking force.

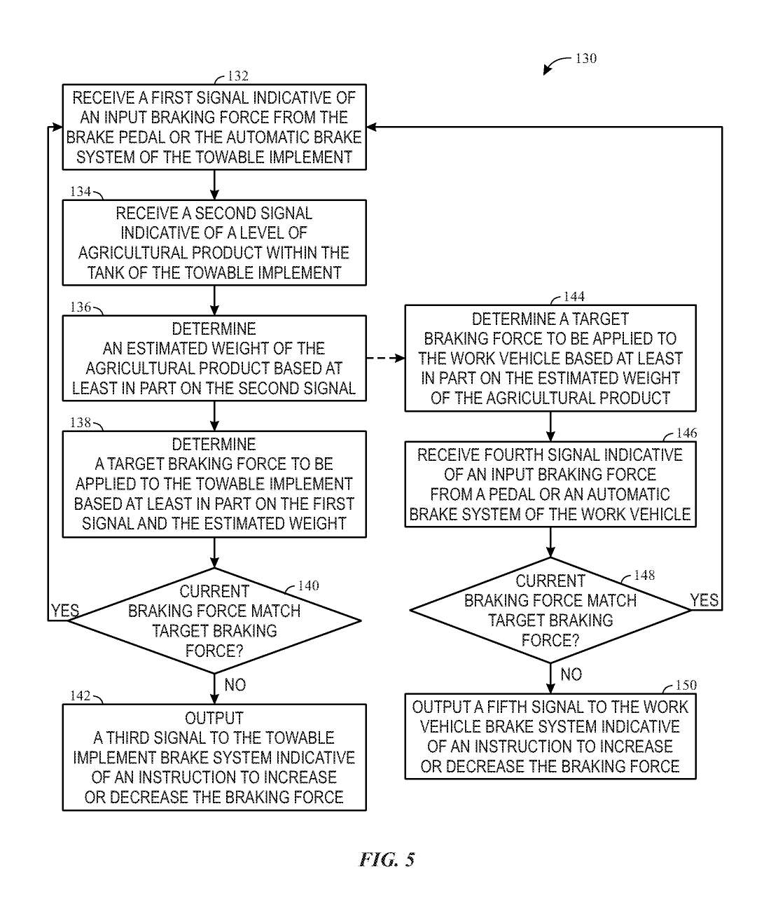

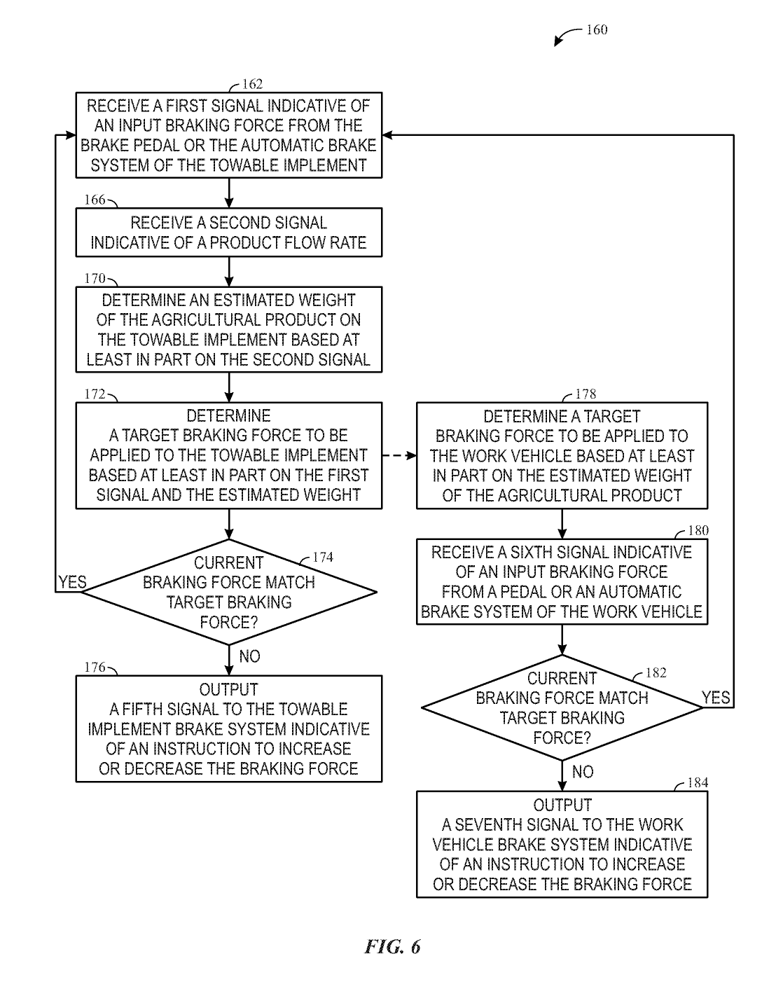

The method 100 may be repeated throughout the application or harvesting operation to control the braking force applied to the wheels of the towable implement and/or to the wheels of the work vehicle in real-time or near real-time as the weight of the of the agricultural product within the towable implement varies. While the method 100 utilizes a measured weight of the agricultural product within the towable implement, in some embodiments, the braking force the towable implement brake system and/or the work vehicle brake system may be controlled using an estimated weight of the agricultural product within the towable implement, as discussed in greater detail with reference to FIGS. 5 and 6.

FIG. 5 is a flow diagram of another embodiment of a method 130 for calibrating the braking force applied to the wheels of the towable implement and/or to the wheels of the work vehicle of the agricultural system of FIG. 1. The method 130 may include determination of an estimated weight of the agricultural product within the towable implement at a given time based at least in part on signals received from the level sensor, and adjustment of one or more braking forces based at least in part on the estimated weight. First, as represented by block 132, a first signal indicative of an input braking force from the brake pedal or from the automatic brake system of the towable implement may be received by the braking force controller. Next, as represented by block 134, a second signal indicative of a level (e.g., fill level) of the agricultural product within the tank of the towable implement may be received by the braking force controller from the level sensor or the towable implement controller. Next, as represented by block 136, the braking force controller may determine an estimated weight of the agricultural product within the tank of the towable implement based at least in part on the second signal indicative of the agricultural product level within the tank.

Next, as represented by block 138, based at least in part on the first signal and the determined estimated weight, the braking force controller may determine a target braking force to be applied by the towable implement brake system to stop or reduce the speed of the towable implement. The target braking force may be calibrated for the current weight of the agricultural product within the towable implement, and as such, the current estimated weight of the towable implement. Next, similar to the method 100 and as represented by block 140, the braking force controller may determine whether a current braking force of the towable implement brake system matches the target braking force of the towable implement brake system. The current braking force may be received by the controller from the one or more towable implement brake force sensors. If the current braking force matches the target braking force, the method 130 may begin again with block 132 and continue throughout the operation as a braking force is applied to stop or reduce the speed of the towable implement and the weight of the agricultural product on the towable implement changes. If the braking force controller determines that the current braking force does not match the target braking force for the towable implement brake system, the braking force controller may output a third signal to the towable implement brake system, or the individual actuators of the individual brakes of the towable implement, indicative of the target braking force and/or indicative of an instruction to either increase or decrease the current braking force to match the target braking force, as represented by block 142. Calibration of the braking force applied by the towable implement brake system based on real-time or near real-time estimated weight of the agricultural product within the towable implement during application or harvesting operations may enable a decrease in locking of the wheels of the towable implement and/or the wheels of the work vehicle when the weight of the agricultural product within the tank is low, and a decrease in increased stopping distance when the weight of the agricultural product within the tank is high.

In some embodiments, the braking force controller may next receive signals from the one or more towable implement braking force sensor that may be utilized by the braking force controller as feedback to determine whether the current braking force of the towable implement brake system matches the target braking force. Based on this comparison, in some embodiments, the braking force controller may output a signal indicative of instructions to further adjust the current braking force of the towable implement brake system if the current braking force does not match the target braking force.

Similar to the method 100, in some embodiments, the braking force controller may control the braking force applied by the work vehicle brake system to stop or reduce the speed of the work vehicle. After the estimated weight of the agricultural product within the towable implement is determined by the braking force controller (block 104), the braking force controller may determine a target braking force for the work vehicle brake system based at least in part on the estimated weight of the agricultural product within the towable implement, as represented by block 144. The braking force controller may further determine the target braking force of the work vehicle brake system based at least in part on a received fourth signal indicative of an input braking force of the brake pedal or the automatic brake system of the work vehicle (block 146). Next, as represented by block 148, the braking force controller may determine whether a current braking force matches the target braking force of the work vehicle brake system. The current braking force may be received by the controller from the one or more work vehicle brake force sensors. If the current braking force matches the target braking force, the method 130 may begin again with block 132 and continue throughout the operation as a braking force is applied to stop or reduce the speed of the towable implement and the weight of the agricultural product on the towable implement changes. If the braking force controller determines that the current braking force does not match the target braking force for the work vehicle brake system, the braking force controller may output a fifth signal to the work vehicle brake system, or the individual actuators of the individual brakes of the work vehicle, indicative of the target braking force and/or of an instruction to either increase or decrease the current braking force to match the target braking force, as represented by block 150. Calibration of the braking force applied by the work vehicle brake system based on real-time or near real-time weight of the agricultural product within the towable implement during application or harvesting operations may enable a decrease in locking of the wheels of the towable implement and/or the wheels of the work vehicle when the weight of the agricultural product within the tank is low, and a decrease in increased stopping distance when the weight of the agricultural product within the tank is high.

The method 130 may be repeated throughout the application or harvesting operation to control the braking force applied to the wheels of the towable implement and/or to the wheels of the work vehicle as the weight of the agricultural produce within the towable implement varies. While the method 130 utilizes an estimated weight of the agricultural product within the towable implement of the agricultural system determined based at least in part on the fill level of the agricultural product within the tank of the towable implement, an estimated weight of the agricultural product may be determined based on other inputs. For example, the estimated weight may be determined based at least in part on an application or harvest rate, as discussed in FIG. 6.

FIG. 6 is a flow diagram of a further embodiment of a method 160 for adjusting the braking force applied to the wheels of the towable implement and/or to the wheels of the work vehicle of the agricultural system of FIG. 1. The method 160 may include determination of an estimated weight of the agricultural product within the towable implement at time based at least in part on signals received from the product flow sensor, and adjustment of one or more braking forces based at least in part on the estimated weight. First, as represented by block 162, a first signal indicative of an operational start time of the application or harvesting operation. The first signal may be received as an input from an operator or from a sensor or a timer. Next, as represented by block 166, a second signal indicative of a product flow rate of the agricultural product conveyed to or from the tank of the towable implement may be received by the braking force control system from the product flow sensor.

Next, as represented by block 170, the braking force controller may determine an estimated weight of the agricultural product within the tank of the towable implement based at least in part on the second signal. The braking force controller may multiply the product flow rate by the time at that rate, or the braking force controller may determine the rate at a particular interval of time and multiply the product flow rate by the interval time. Next, as represented by block 172, based at least in part on the first signal and the determined estimated weight, the braking force controller may determine a target braking force to be applied by the towable implement brake system to stop or reduce the speed of the towable implement. The target braking force may be calibrated for the current estimated weight of the agricultural product within the towable implement, and as such, the current weight of the towable implement.

Next, as represented by block 174, the braking force controller may determine whether a current braking force matches the target braking force of the towable implement brake system. The current braking force may be received by the controller from the one or more towable implement brake force sensors. If the current braking force matches the target braking force, the method 160 may begin again with block 164 and continue throughout the operation as a braking force is applied to stop or reduce the speed of the towable implement and the weight of the agricultural product on the towable implement changes. If the braking force controller determines that the current braking force does not match the target braking force for the towable implement brake system, the braking force controller may output a third signal to the towable implement brake system, or the individual actuators of the individual brakes of the towable implement, indicative of the target braking force and/or of an instruction to either increase or decrease the current braking force to match the target braking force, as represented by block 176. Calibration of the braking force applied by the towable implement brake system based on real-time or near real-time estimated weight of the agricultural product within the towable implement during application or harvesting operations may enable a decrease in locking of the wheels of the towable implement and/or the wheels of the work vehicle when the weight of the agricultural product within the tank is low, and a decrease in increased stopping distance when the weight of the agricultural product within the tank is high.

In some embodiments, the braking force controller may next receive signals from the one or more towable implement braking force sensor that may be utilized by the braking force controller as feedback to determine whether the current braking force of the towable implement brake system matches the target braking force. Based on this comparison, in some embodiments, the braking force controller may output a signal indicative of instructions to further adjust the current braking force of the towable implement brake system if the current braking force does not match the target braking force.

Similar to the method 100 and the method 130, in some embodiments, the braking force controller may control the braking force applied by the work vehicle brake system to stop or reduce the speed of the work vehicle. After the estimated weight of the agricultural product within the towable implement is determined by the braking force controller (block 170), the braking force controller may determine a target braking force for the work vehicle brake system based at least in part on the estimated weight of the agricultural product within the towable implement, as represented by block 178. The braking force controller may further determine the target braking force of the work vehicle brake system based at least in part on a received sixth signal indicative of an input braking force by the brake pedal or the automatic brake system of the work vehicle (block 180). Next, as represented by block 182, the braking force controller may determine whether a current braking force matches the target braking force of the work vehicle brake system. The current braking force may be received by the controller from the one or more work vehicle brake force sensors. If the current braking force matches the target braking force, the method 160 may begin again with block 164 and continue throughout the operation as a braking force is applied to stop or reduce the speed of the towable implement and the weight of the agricultural product on the towable implement changes. If the braking force controller determines that the current braking force does not match the target braking force for the work vehicle brake system, the braking force controller may output a seventh signal to the work vehicle brake system, or the individual actuators of the individual brakes of the work vehicle, indicative of the target braking force and/or of an instruction to either increase or decrease the current braking force to match the target braking force, as represented by block 184. Calibration of the braking force applied by the work vehicle brake system based on real-time or near real-time weight of the agricultural product within the towable implement during application or harvesting operations may enable a decrease in locking of the wheels of the towable implement and/or the wheels of the work vehicle when the weight of the agricultural product within the tank is low, and a decrease in increased stopping distance when the weight of the agricultural product within the tank is high.

It should be understood that the methods 100, 130, and 160 may be performed individually or in combination to adjust the braking force applied to the wheels of the towable implement of the agricultural system and/or to adjust the braking force applied to the wheels of the work vehicle based at least in part on a changing weight of the agricultural product within the towable implement in real-time or near real-time during application or harvesting operations.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

1. A braking force control system for an agricultural system, comprising a controller comprising a memory and a processor, wherein the controller is configured to:
receive a first signal indicative of a first input braking force of a towable implement brake system of a towable implement of the agricultural system;
receive a second signal indicative of a first weight of an agricultural product within the towable implement at a first time;
determine a first target braking force of the towable implement brake system based at least in part on the first signal and the second signal;
determine whether a first current braking force of the towable implement brake system corresponds to the first target braking force of the towable implement brake system; and
output to the towable implement brake system, in response to determining that the first current braking force of the towable implement brake system does not correspond to the first target braking force of the towable implement brake system, a third signal indicative of the first target braking force of the towable implement brake system.

2. The braking force control system of claim 1, wherein the first signal is received from a brake pedal or an automatic brake control system of the agricultural system.

3. The braking force control system of claim 1, wherein the controller is configured to:
receive a fourth signal indicative of a second input braking force of the towable implement brake system;
receive a fifth signal indicative of a second weight of the agricultural product within the towable implement at a second time;
determine a second target braking force of the towable implement brake system based at least in part on the fourth signal and the fifth signal;
determine whether a second current braking force of the towable implement brake system corresponds to the second target braking force of the towable implement brake system; and
output to the towable implement brake system, in response to determining that the second current braking force of the towable implement brake system does not correspond to the second target braking force of the towable implement brake system, a sixth signal indicative of the second target braking force of the towable implement brake system.

4. The braking force control system of claim 1, wherein the third signal is output to one or more actuators of the towable implement brake system, and the third signal is indicative of an instruction to either increase or decrease the first current braking force of the towable implement brake system to correspond to the first target braking force of the towable implement brake system.

5. The braking force control system of claim 4, wherein the controller is configured to receive a fourth signal indicative of a current braking force of the towable implement brake system, and the controller is configured to utilize the fourth signal as feedback to determine whether the first current braking force of the towable implement brake system corresponds to the first target braking force of the towable implement brake system.

6. The braking force control system of claim 1, wherein the controller is configured to:
receive a fourth signal indicative of a third input braking force of a work vehicle brake system of a work vehicle of the agricultural system, wherein the fourth signal is received from a brake pedal or an automatic brake control system of the agricultural system, and the work vehicle is configured to tow the towable implement;
determine a third target braking force of the work vehicle brake system based at least in part on the second signal and the fourth signal;
determine whether a third current braking force of the work vehicle brake system corresponds to the third target braking force of the work vehicle brake system; and
output to the work vehicle brake system, in response to determining that the third current braking force of the work vehicle brake system does not correspond to the third target braking force of the work vehicle brake system, a fifth signal indicative of the third target braking force of the work vehicle brake system.

7. The braking force control system of claim 6, wherein the controller is configured to:
receive a sixth signal indicative of a fourth input braking force of the work vehicle brake system;
receive a seventh signal indicative of a third weight of the agricultural product within the towable implement at a second time;
determine a fourth target braking force of the work vehicle brake system based at least in part on the sixth signal and the seventh signal;
determine whether a fourth current braking force of the work vehicle brake system corresponds to the second target braking force of the work vehicle brake system; and
output to the work vehicle brake system, in response to determining that the fourth current braking force of the work vehicle brake system does not correspond to the fourth target braking force of the work vehicle brake system, an eighth signal indicative of the fourth target braking force of the work vehicle brake system, wherein the work vehicle brake system is communicatively coupled to the controller via an ISOBUS network.

8. The braking force control system of claim 1, comprising a scale sensor communicatively coupled to the controller, wherein the scale sensor is configured to measure the first weight of the agricultural product within the towable implement and to output the second signal to the controller.

9. The braking force control system of claim 1, comprising a level sensor communicatively coupled to the controller, wherein the level sensor is configured to measure a fill level of the agricultural product within the towable implement and to output the second signal to the controller, wherein the controller is configured to determine the first weight of the agricultural product based at least in part on the fill level.

10. The braking force control system of claim 1, comprising a product flow sensor communicatively coupled to the controller, wherein the product flow sensor is configured to measure a product flow rate of the agricultural product to or from the towable implement and to output the second signal, wherein the controller is configured to determine first weight of the agricultural product based at least in part on the product flow rate.

11. A braking force control system for an agricultural system, comprising a controller comprising a memory and a processor, wherein the controller is configured to:
receive a first signal indicative of an first input braking force of a towable implement brake system of a towable implement of the agricultural system, wherein the first signal is received from a brake pedal or an automatic brake control system of the agricultural system;
receive a second signal indicative of a fill level of an agricultural product within the towable implement;
determine an estimated weight of the agricultural product based at least in part on the second signal;
determine a first target braking force of the towable implement brake system based at least in part on the first signal and the estimated weight;
determine whether a first current braking force of the towable implement brake system corresponds to the first target braking force of the towable implement brake system; and
output to the towable implement brake system, in response to determining that the first current braking force of the towable implement brake system does not correspond to the first target braking force of the towable implement brake system, a third signal indicative of the first target braking force of the towable implement brake system.

12. The braking force control system of claim 11, wherein the controller is configured to:
receive a fourth signal indicative of a second input braking force of a work vehicle brake system of a work vehicle of the agricultural system, wherein the work vehicle is configured to tow the towable implement;
determine a second target braking force of the work vehicle brake system based at least in part on the estimated weight;
determine whether a second current braking force of the work vehicle brake system corresponds to the second target braking force of the work vehicle brake system; and
output to the work vehicle brake system, in response to determining that the second current braking force of the work vehicle brake system does not correspond to the second target braking force of the work vehicle brake system, a fifth signal indicative of the second target braking force for the work vehicle brake system.

13. The braking force control system of claim 11, wherein the third signal is output to one or more actuators of the towable implement brake system, wherein the third signal is indicative of an instruction to either increase or decrease the first current braking force of the towable implement brake system to correspond to the first target braking force of the towable implement brake system.

14. The braking force control system of claim 13, comprising a towable implement braking force sensor communicatively coupled to the controller, wherein the towable implement braking force sensor is configured to measure a current braking force and to output a fourth signal to the controller indicative of the current braking force, wherein the controller is configured to receive the fourth signal and utilize the fourth signal as feedback to determine whether the first current braking force corresponds to the first target braking force.

15. The braking force control system of claim 11, wherein the controller is configured to control the first current braking force of the towable implement brake system in real-time or near real time as the estimated weight of the agricultural product changes.

16. The braking force control system of claim 11, comprising a level sensor communicatively coupled to the controller and configured to be disposed within a tank of the towable implement configured to store the agricultural product, wherein the level sensor is configured to measure the fill level of the agricultural product and to output the second signal.

17. A braking force control system of an agricultural system, comprising a controller comprising a memory and a processor, wherein the controller is configured to:
receive a first signal indicative of a first input braking force of a towable implement brake system of a towable implement of the agricultural system, wherein the first signal is received from a brake pedal or an automatic brake control system of the agricultural system;
receive a second signal indicative of a product flow rate of the agricultural product to or from the towable implement;
determine an estimated weight of the agricultural product within the towable implement based at least in part on the second signal;
determine a first target braking force of the towable implement brake system based at least in part on the first signal and the estimated weight;
determine whether a first current braking force of the towable implement brake system corresponds to the first target braking force of the towable implement brake system; and
output to the towable implement brake system, in response to determining that the first current braking force of the towable implement brake system does not correspond to the first target braking force of the towable implement brake system, a fifth signal indicative of the first target braking force of the towable implement brake system.

18. The braking force control system of claim 17, wherein the controller is configured to:
receive a sixth signal indicative of a second input braking force of a work vehicle brake system of a work vehicle of the agricultural system, wherein the work vehicle is configured to tow the towable implement;
determine a second target braking force of the work vehicle brake system based at least in part on the sixth signal and the estimated weight;
determine whether a second current braking force of the work vehicle brake system corresponds to the second target braking force of the work vehicle brake system; and
output to the work vehicle brake system, in response to determining that the second current braking force of the work vehicle brake system does not correspond to the second target braking force of the work vehicle brake system, a seventh signal indicative of the current target braking force of the work vehicle brake system.

19. The braking force control system of claim 17, comprising a product flow sensor communicatively coupled to the controller and configured to be disposed along a conduit configured to convey the agricultural product to or from the towable implement, wherein the product flow sensor is configured to measure the product flow rate and to output the second signal, the controller is configured to multiply the product flow rate by a time interval to determine an amount of the agricultural product that has been conveyed into or out of the towable implement, and the controller is configured to determine the estimated weight of the agricultural product based at least in part on the amount of the agricultural product that has been conveyed into or out of the towable implement.

20. The braking force control system of claim 17, wherein the fifth signal is output to one or more actuators of the towable implement brake system, wherein the fifth signal is indicative of an instruction to either increase or decrease the input braking force of the towable implement brake system to correspond to the first target braking force of the towable implement brake system.
